(19) United States
(12) Patent Application Publication
(10) Pub. No.: US 2012/0085482 A1
(43) Pub. Date: Apr. 12, 2012

(54) PROCESS FOR PRODUCING GLASS LAMINATES

(75) Inventors: Robert J. Cadwallander, Angier, NC (US); Richard Allen Hayes, Beaumont, TX (US); Steven C. Pesek, Orange, TX (US); Sam Louis Samuels, Landenberg, PA (US); Charles Anthony Smith, Vienna, WV (US)

(73) Assignee: E. I. DU PONT DE NEMOURS AND COMPANY, Wilmington, DE (US)

(21) Appl. No.: 13/329,021

(22) Filed: Dec. 16, 2011

Related U.S. Application Data
(62) Division of application No. 11/985,705, filed on Nov. 16, 2007.

(51) Int. Cl. B32B 37/10

(52) U.S. Cl. 156/104; 156/286

(57) ABSTRACT

A non-autoclave process of manufacturing a glass laminate comprising: (a) providing an assembly comprising (i) a first rigid sheet layer, and (ii) an interlayer sheet comprising a copolymer comprising units from an alpha olefin and about 17 weight to about 25 weight % of units from an alpha, beta-ethylenically unsaturated carboxylic acid, groups wherein about 1 to about 100 mole % of the carboxylic acid groups are neutralized with metal ions; and (b) forming the glass laminate from the assembly without use of an autoclave comprising in sequence (i) applying vacuum to the assembly; and (ii) applying heat to the assembly while still under vacuum.

### PRIORITY

This is a divisional of U.S. patent application Ser. No. 11/985,705, filed Nov. 16, 2007, which is incorporated herein by reference in its entirety.

### FIELD OF THE INVENTION

The present invention relates to processes for producing glass laminates using certain ethylene acid copolymer ionomer sheets.

### BACKGROUND OF THE INVENTION

Glass laminated products have contributed to society for almost a century. Beyond the well known, every day automotive safety glass used in windshields, laminated glass is used in all forms of the transportation industry. It is utilized as windows for trains, airplanes, ships, and nearly every other mode of transportation. Safety glass is characterized by high impact and penetration resistance and does not scatter glass shards and debris when shattered.

Safety glass typically consists of a sandwich of two glass sheets or panels bonded together with an interlayer of a polymeric sheet which is placed between the two glass sheets. One or both of the glass sheets may be replaced with optically clear rigid polymeric sheets, such as sheets of polycarbonate materials. Safety glass has further evolved to include multiple layers of glass and polymeric sheets bonded together with interlayers of polymeric films or sheets.

The interlayer is typically made with a relatively thick polymeric sheet which exhibits toughness and bondability to provide adhesion to the glass in the event of a crack or crash. Over the years, a wide variety of polymeric interlayers have been developed to produce laminated products. In general, these polymeric interlayers must possess a combination of characteristics including very high optical clarity (low haze), high impact resistance, high penetration resistance, excellent ultraviolet light resistance, good long term thermal stability, excellent adhesion to glass and other rigid polymeric sheets, low ultraviolet light transmittance, low moisture absorption, high moisture resistance, excellent long term weatherability, among other requirements. Widely used interlayer materials utilized currently include complex multicomponent compositions based on polyvinylbutyral (PVB), polyurethane (PU), polyvinylchloride (PVC), metallocene-catalyzed linear low density polyethylenes, ethylenevinyl acetate (EVAc), copolyethylene ionomers, polymeric fatty acid polyamides, polyester resins, such as poly(ethylene terephthalate), silicone elastomers, epoxy resins, elastomeric polycarbonates, and the like.

A more recent trend has been the use of glass laminated products in the construction business for homes and office structures. The use of architectural glass has expanded rapidly over the years as designers incorporated more glass surfaces into buildings. Threat resistance has become an ever increasing requirement for architectural glass laminated products. These newer products are designed to resist both natural and man-made disasters. Examples of these needs include the recent developments of hurricane resistant glass, now mandated in hurricane susceptible areas, theft resistant glazings, and the more recent blast resistant glass laminated products designed to protect buildings and their occupants. These products have great enough strength to resist intrusion even after the glass laminate has been broken. For example; when a glass laminate is subjected to high force winds and impact of flying debris as occurs in a hurricane or where there are repeated impacts on a window by a criminal attempting to break into a vehicle or structure. In addition, glass laminated products have now reached the strength requirements for being incorporated as structural elements within buildings. An example of this would be glass staircases now being featured in many buildings.

Ethylene acid copolymer ionomeric interlayers have been developed over the past half century to meet these ever more demanding societal needs, as can be seen from (for example) U.S. Pat. No. 3,344,014, U.S. Pat. No. 4,663,228, U.S. Pat. No. 4,668,574, U.S. Pat. No. 5,759,698, U.S. Pat. No. 5,763,062, U.S. Pat. No. 6,432,522, US 2002/0155302, US 2003/0044579, WO 99/58334, WO 00/64670, WO 2004/011755 and WO 2006/057771.

Laminates have generally been produced through the art by autoclave processes. Autoclave lamination processes are well known and generally comprise a temperature of about 120° C. to about 180° C. at a pressure of about 100 psig to about 300 psig for about 10 to about 60 minutes. The shortcomings of autoclave lamination processes are well known within the art and include multistep complicated processes which do not allow for continuous processes utilizing autoclave equipment which is costly and difficult to maintain.

Non-autoclave processes have been disclosed within the art which overcome some of the above mentioned shortcomings of autoclave processes. For example, Morris, in U.S. Pat. No. 3,234,062, discloses non-autoclave processes for the production of glass laminates which utilize a poly(vinyl butyral) (PVB) interlayer through the application of vacuum and heat. As one skilled within the art would appreciate, such non-autoclave lamination processes may not translate to interlayer materials which are chemically and physically distinct. For example, ethylene acid copolymer ionomers have modulus which are generally an order of magnitude greater than found for PVB.

Although some disclosures generically disclose the use of non-autoclave processes for the production of laminates which incorporate ethylene copolymer ionomeric interlayers, very little specific information has been disclosed. For example, the above mentioned WO 2006/057771 discloses certain non-autoclave lamination processes which do not include vacuum. Chick, in US 2004/0182493, discloses a non-autoclave process for the production of glass laminates which may include interlayers of a film of ionplast plastic along with other interlayer materials, such as polyvinyl butyral, urethane, and silicone. The non-autoclave process includes successive heating zones and nip rolls. He teaches against the use of vacuum within the non-autoclave lamination process. U.S. Pat. No. 5,759,698 describes use of ethylene acid copolymer ionomers in making glass laminates using a non-autoclave process and describes a vacuum step in the examples. Examples of the copolymers include copolymers containing methacrylic acid and neutralized with sodium ion (Himilan 1856, Mitsui du Pont Chemical KK (MDC)), containing methacrylic acid and neutralized with sodium (Himilan 1707, MDC), and terpoly(ethylene-co-isobutylacrylate-co-methacrylic acid) containing which is neutralized with zinc (Himilan 1855, MDC). However, U.S. Pat. No. 5,759,698 is primarily directed to use a combination of organic peroxides and silane coupling agents in making glass laminates, which practice is not preferred. U.S. Pat. No. 5,759,698 further suffers the shortcoming of not teaching high modulus interlayers that are required to provide the threat resistant glass laminates desired.

The present invention overcomes the shortcomings of the background art and provides laminates which incorporate sheets of certain ethylene copolymer ionomers produced through non-autoclave processes with enhanced throughput yields and, in preferable embodiments, with higher adhesion to glass than heretofore seen.

### SUMMARY OF THE INVENTION

A non-autoclave process of manufacturing a glass laminate comprising: (a) providing an assembly comprising (i) a first rigid sheet layer, and (ii) an interlayer sheet comprising a copolymer comprising units from an alpha olefin and about 17 weight % to about 25 weight % of units from an alpha, beta-ethylenically unsaturated carboxylic acid, groups wherein about 1 to about 100 mole % of the carboxylic acid groups are neutralized with metal ions selected from the group consisting of sodium, zinc, and mixtures thereof; and (b) forming the glass laminate from the assembly without use of an autoclave comprising in sequence (i) applying vacuum to the assembly; and (ii) applying heat to the assembly while still under vacuum.

Preferably the carboxylic is neutralized to about 20 to about 80% with metal ions.

Preferably the alpha,beta-ethylenically unsaturated carboxylic acid comonomers are selected from the group consisting of acrylic acid, methacrylic acid, and mixtures thereof. More preferably, the copolymer is copoly(ethylene-co-methacrylic acid).

Preferably the process is carried out without use of organic peroxides in the interlayer. More preferably, the process is carried out without use of any crosslinking agents in the interlayer.

Preferably, the interlayer sheet has a thickness of about 20 to about 300 mils. More preferably, the interlayer sheet has a thickness of about 30 to 180 mils.

Preferably, the copolymers incorporate about 17 weight % to about 23 weight % and more preferably incorporate about 20 weight % to about 23 weight % of the alpha,beta-ethylenically unsaturated carboxylic acid comonomers, based on the total weight of the polymer.

Preferably wherein the step (ii) of lamination is conducted by subjecting the assembly to vacuum for about 1 to about 30 minutes.

Preferably the applying vacuum is carried out at a temperature from about 50 to about 130 C, more preferably about 65 C.

Preferably the applying vacuum is conducted by applying a vacuum of about 20 mm Hg to about 400 mm Hg, preferably about 20 to about 100 Hg, more preferably about 25 to about 50 mm Hg (absolute pressure). Preferably the applying vacuum is carried out by applying the vacuum at a temperature from about 10° C. to about 50° C. and the applying heat to the assembly while still under vacuum is conducted by subjecting the assembly to heat for about 15 to about 60 minutes at a temperature from about 100° C. to about 135° C.

Preferably the applying heat to the assembly while still under vacuum is conducted by subjecting the assembly to heat for about 1 to about 60 minutes, more preferably for about 15 to about 60 minutes.

Preferably the applying heat to the assembly while still under vacuum is conducted by subjecting the assembly to heat at a temperature from about 80° C. to about 160° C., more preferably from about 100° C. to about 135° C.

In a preferred embodiment, the assembly comprises from top to bottom (i) the first rigid sheet layer, (ii) the interlayer sheet, and (iii) a second rigid sheet layer. Preferably the first rigid sheet layer is a glass sheet. Preferably the second rigid sheet layer is a glass sheet. In one preferred embodiment, the assembly does not contain any other layers. In another preferred embodiment, the assembly contains an optional layer selected from the group consisting of polymeric films and polyvinyl butyral sheets.

In another preferred embodiment, the assembly comprises from top to bottom (i) the first rigid sheet layer, (ii) the interlayer sheet, and (iii) a film. Preferably the film is a polyester film, more preferably poly(ethylene terephthalate) film, and most preferably biaxially-oriented poly(ethylene terephthalate) film.

In a preferred embodiment, the forming the glass laminate consists essentially of: (i) the applying vacuum to the assembly; (ii) the applying heat to the assembly while still under vacuum; and (iii) cooling the assembly. In a preferred embodiment, pressure is applied to assembly between step (ii) and step (iii) and/or between step (iii) and step (iv), preferably through nip rolls. Preferably either or both of the applying heat to the assembly while still under vacuum and the applying heat to the assembly to complete the lamination is conducted by supplying heat from infrared lamps. In another preferred embodiment, the applying vacuum to the assembly is conducted by subjecting the assembly to vacuum for about 1 to about 30 minutes at a temperature from about 10° C. to about 50° C. and at a vacuum of about 20 mm Hg to about 400 mm Hg (absolute pressure); the applying heat to the assembly while still under vacuum is conducted by subjecting the assembly to a temperature from about 40° C. to about 90° C., more preferably about 60° C. to about 80° C., for about 1 to about 60 minutes, more preferably for about 15 to about 60 minutes; the applying heat to the assembly to complete the lamination is conducted by subjecting the assembly to a temperature from about 80° C. to about 160° C., more preferably about 100° C. to about 135° C., for about 1 to about 60 minutes, more preferably about 15 to about 60 minutes, at atmospheric pressure.

In another preferred embodiment, the forming the glass laminate comprises: (i) the applying vacuum to the assembly to remove air; (ii) the applying heat to the assembly while still under vacuum, wherein the applying heat to the assembly is carried out under conditions to form an edge seal; (iii) applying heat to the assembly to complete the lamination; and (iv) cooling the laminate. Preferably the step (iii) of applying heat to the assembly is conducted at atmospheric pressure. Preferably pressure is applied to assembly between step (ii) and step (iii) and/or between step (iii) and step (iv). Preferably the pressure is applied through nip rolls.

Preferably the process is semi-continuous.

In one preferred embodiment, the forming the glass laminate consists essentially of: (i) applying vacuum to the assembly; (ii) applying heat to the assembly while still under vacuum to form an edge seal; (iii) applying pressure to the assembly by nip rolls; (iv) applying heat to the assembly at atmospheric pressure to complete the lamination; and (v) cooling the laminate. Preferably the step (iii) of applying pressure to the assembly is performed after the removal of vacuum. The nip rolls can be heated.

In another preferred embodiment, the forming the glass laminate comprises placing the assembly in a vacuum bag, drawing air out of the bag using a vacuum means for a period of about 1 minute to about 1 hour, sealing the vacuum bag while maintaining the vacuum, placing the sealed bag in an oven at a temperature of about 100° C. to about 200° C. for from about 10 to about 50 minutes. Preferably the vacuum bag is heated at a temperature of from about 120° C. to about 160° C. for 20 minutes to about 45 minutes. Preferably the process further comprises removing the vacuum and then further heating at a temperature of about 100° C. to about 180° C. for about 1 minute to about 1 hour.

In yet another preferred embodiment, the forming the glass laminate comprises placing the assembly in a vacuum bag, drawing air out of the bag using a vacuum means for a period of about 1 minute to about 1 hour, sealing the vacuum bag while maintaining the vacuum, placing the sealed bag in an oven at a temperature of about 50° C. to about 100° C. for from about 1 minute to about 1 hour, releasing the vacuum, and heating further at about 100° C. to about 200° C. for from about 10 to about 50 minutes. Preferably the forming the glass laminate is carried out using an edge-sealed press assembly including nip rolls for applying pressure to the assembly.

In a preferred embodiment, the invention is directed to a non-autoclave process of manufacturing a glass laminate comprising: (a) providing an assembly comprising (i) a first rigid sheet layer, and (ii) an interlayer sheet comprising a copolymer comprising units from an alpha olefin and about 17 weight % to about 25 weight % of units from an alpha, beta-ethylenically unsaturated carboxylic acid, groups wherein about 1 to about 100 mole % of the carboxylic acid groups are neutralized with metal ions selected from the group consisting of sodium, zinc, and mixtures thereof; and (b) forming the glass laminate from the assembly without use of an autoclave and without use of a vacuum bag or ring, comprising in sequence (i) placing the assembly in an atmosphere that has an absolute pressure of 0 to 300 mm Hg (preferably 0 to about 100 Hg) to remove air; and (ii) sealing the edges of the assembly while applying heat. Preferably step (b)(i) is carried out by placing the assembly in a vacuum chamber. Preferably the sealing is carried out at about atmospheric pressure and about 80 to about 160° C. (preferably about 100 to about 140° C.). Preferably the sealing is carried out by using a mechanical sealing means selected from the group consisting of nip rolls and press frame and the like, preferably a nip roll operation at atmospheric conditions.

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of limits the scope of a claim to the specified materials or steps and those that do not materially affect the basic and novel characteristic(s) of the claimed invention. “A ‘consisting essentially of claim occupies a middle ground between closed claims that are written in a ‘consisting of format and fully open claims that are drafted in a ‘comprising’ format.”

Where applicants have defined an invention or a portion thereof with an open-ended term such as “comprising,” it should be readily understood that (unless otherwise stated) the description should be interpreted to also describe such an invention using the terms “consisting essentially of or “consisting of.”

Use of “a” or “an” are employed to describe elements and components of the invention. This is done merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

In one embodiment, the invention is a polymeric interlayer suitable for use in laminate structures produced through a non-autoclave lamination process which comprise a vacuum step.

The polymeric interlayer sheet is comprised of certain copolymers produced from ethylene and alpha,beta-ethylenically unsaturated carboxylic acid comonomers which have been neutralized with metal ions. The copolymers incorporate from about 17 weight % to about 25 weight % of the alpha,beta-ethylenically unsaturated carboxylic acid comonomers based on the total weight of the polymer. Preferably, the copolymers incorporate about 17 weight % to about 23 weight % and more preferably incorporate about 20 weight % to about 23 weight % of the alpha,beta-ethylenically unsaturated carboxylic acid comonomers, based on the total weight of the polymer.

Preferably, the alpha,beta-ethylenically unsaturated carboxylic acid comonomers are selected from the group consisting of acrylic acid, methacrylic acid, itaconic acid, maleic acid, maleic anhydride, fumaric acid, monomethyl maleic acid, and mixtures thereof. More preferably, the alpha,beta-ethylenically unsaturated carboxylic acid comonomers are selected from the group consisting of acrylic acid, methacrylic acid, and mixtures thereof.

The ethylene copolymers may optionally contain other unsaturated comonomers. Specific examples of preferable other unsaturated comonomers may be selected from the group consisting of; methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol) methyl ether acrylate, poly(ethylene glycol) methyl ether methacrylate, poly(ethylene glycol) behenyl ether acrylate, poly(ethylene glycol) behenyl ether methacrylate, poly(ethylene glycol) 4-nonylphenyl ether acrylate, poly(ethylene glycol) 4-nonylphenyl ether methacrylate, poly(ethylene glycol) phenyl ether acrylate, poly(ethylene glycol) phenyl ether methacrylate, dimethyl maleate, diethyl maleate, dibutyl maleate, dimethyl fumarate, diethyl fumarate, dibutyl fumarate, dimenthyl fumarate, vinyl acetate, vinyl propionate, and the like and mixtures thereof. Preferably, the other unsaturated comonomers are selected from the group consisting of; methyl acrylate, methyl methacrylate, butyl acrylate, butyl methacrylate, glycidyl methacrylate, vinyl acetate, and mixtures thereof. Preferably, the ethylene copolymers incorporate about 0 to about 50 weight %, more preferably about 0 to about 25 weight %, and most preferably, about 0 weight % to about 10 weight %, of the other unsaturated comonomer, based on the total weight of the composition. The ethylene copolymers may be polymerized as disclosed, for example, in U.S. Pat. No. 3,404,134, U.S. Pat. No. 5,028,674, U.S. Pat. No. 6,500,888 and U.S. Pat. No. 6,518,365.

Preferred is neutralized copoly(ethylene-co-methacrylic acid), which is a fully or partially neutralized dipolymer containing units from methacrylic acid.

The ethylene copolymers are neutralized from about 1 to about 100% (mole %) with metallic ions based on the total carboxylic acid content. The metal ions used in this invention are selected from the group consisting of sodium, zinc, and mixtures thereof. No other metal ions are used. Sodium metallic ion is preferred due to high optical clarity. Zinc metallic ion is most preferred due to high moisture resistance. Most preferably, the metallic ion is zinc due to the surprisingly enhanced adhesion to glass. Preferably, the ethylene copolymers are neutralized from about 10 to about 90%, more preferably about 20 to about 80%, and most preferably about 20 to about 40%, with metallic ions, based on the total carboxylic acid content.

In one preferred embodiment, the copolymers incorporate from about 17 weight % to about 21 weight % of the alpha,beta-ethylenically unsaturated carboxylic acid comonomers based on the total weight of the polymer. Preferably, these copolymers incorporate about 15 weight % to less than 20 weight %, more preferably incorporate about 18 weight % to less than 20 weight % of the alpha,beta-ethylenically unsaturated carboxylic acid comonomers, based on the total weight of the polymer. Most preferably, the metallic ion is zinc. Even more preferably these compositions are copoly(ethylene-co-methacrylic acid)s, and they are most preferably made with out use of organic peroxides (so that the sheets and the interlayers of the laminates do not contain organic peroxides).

In a more preferred embodiment, the copolymers incorporate from about 20 weight % to about 25 weight % of the alpha,beta-ethylenically unsaturated carboxylic acid comonomers based on the total weight of the polymer. Preferably, these copolymers incorporate 20 weight % to 25 weight %, more preferably incorporate 20 weight % to about 23 weight % of the alpha,beta-ethylenically unsaturated carboxylic acid comonomers, based on the total weight of the polymer. Most preferably, the metallic ion is zinc. Even more preferably these compositions are copoly(ethylene-co-methacrylic acid)s, and they are most preferably made with out use of organic peroxides (so that the sheets and the interlayers of the laminates do not contain organic peroxides).

The ethylene copolymer compositions can further incorporate additives which effectively reduce the melt flow of the resin, to the limit of producing thermoset films and sheets. The use of such additives will enhance the upper end-use temperature of the sheet and laminates. Typically, the end-use temperature will be enhanced up to 20 to 70° C. In addition, laminates produced from such materials will be fire resistant. By reducing the melt flow of the ethylene copolymer interlayer, the material will have a reduced tendency to melt and flow out of the laminate and, in turn, serve as additional fuel for a fire. Specific examples of melt flow reducing additives include organic peroxides, such as 2,5-dimethylhexane-2,5-dihydroperoxide, 2,5-dimethyl-2,5-di(tert-betylperoxy)hexane-3, di-tert-butyl peroxide, tert-butylcumyl peroxide, 2,5-dimethyl-2,5-di(tert-butylperoxy)hexane, dicumyl peroxide, alpha, alpha'-bis(tert-butyl-peroxyisopropyl)benzene, n-butyl-4,4-bis(tert-butylperoxy)valerate, 2,2-bis(tert-butylperoxy)butane, 1,1-bis(tert-butyl-peroxy)cyclohexane, 1,1-bis(tert-butylperoxy)-3,3,5-trimethyl-cyclohexane, tert-butyl peroxybenzoate, benzoyl peroxide, and the like and mixtures combinations thereof. Preferably the organic peroxide decomposes at a temperature of about 100° C. or higher to generate radicals. More preferably, the organic peroxides have a decomposition temperature which affords a half life of 10 hours at about 70° C. or higher to provide improved stability for blending operations. Typically, the organic peroxides will be added at a level of about 0.01 to about 10 weight % based on the total weight of the ethylene copolymer composition. If desired, initiators, such as dibutyltin dilaurate, may be used. Most preferably, the copolymers and products made therefrom (e.g., the interlayers), are not made with and do not contain any peroxides, particularly organic peroxides. Typically, when used, initiators are added at a level of from about 0.01 weight % to about 0.05 weight % based on the total weight of the ethylene copolymer composition. If desired, inhibitors, such as hydroquinone, hydroquinone monomethyl ether, p-benzoquinone, and methylhydroquinone, may be added for the purpose of enhancing control to the reaction and stability. Typically, the inhibitors would be added at a level of less than about 5 weight % based on the total weight of the ethylene copolymer composition. Here, however it is noted that use of initiators and inhibitors is not necessary in many instances, and in a preferred embodiment they are not used.

It is understood that the compositions of the can be used with (or without) additives known within the art. The additives may include plasticizers, processing aides, flow enhancing additives, lubricants, pigments, dyes, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like. For example, typical colorants may include a bluing agent to reduce yellowing, a colorant may be added to color the laminate or control solar light.

The compositions can incorporate an effective amount of a thermal stabilizer. Thermal stabilizers are well disclosed within the art. Any known thermal stabilizer will find utility. Preferable general classes of thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. This should not be considered limiting. Essentially any thermal stabilizer known within the art will find utility. The compositions preferably incorporate 0 to about 10 weight % thermal stabilizers, more preferably 0 to about 5 weight %, even more preferably 0 to about 1 weight % thermal stabilizers, yet even more preferably 0 to about 0.5 weight %, and most preferably 0 to about 0.3 weight %, based on the total weight of the composition. Preferably the minimum level is 0.01 weight %, more preferably 0.01weight. In one preferred embodiment, thermal stabilizers are not used.

The compositions can incorporate an effective amount of UV absorbers. UV absorbers are well disclosed within the art. Any known UV absorber will find utility. Preferable general classes of UV absorbers include benzotriazoles, hydroxybenzophenones, hydroxyphenyl triazines, esters of substituted and unsubstituted benzoic acids, and the like and mixtures thereof. This should not be considered limiting. Essentially any UV absorber known within the art will find utility. The compositions preferably incorporate from about 0.01 to about 10 weight %, more preferably about 0.01 to about 5 weight %, most preferably about 0.01 to about 1 weight %, UV absorbers, based on the total weight of the composition.

The compositions can incorporate an effective amount of hindered amine light stabilizers. Hindered amine light stabilizers (HALS) are well known in the art. Generally, HALS are disclosed to be secondary, tertiary, acetylated, N-hydrocarbyloxy substituted, hydroxy substituted N-hydrocarbyloxy substituted, or other substituted cyclic amines which further incorporate steric hindrance, generally derived from aliphatic substitution on the carbon atoms adjacent to the amine function. This should not be considered limiting, essentially any hindered amine light stabilizer known within the art can be used. The compositions preferably incorporate about 0.01 to about 10.0 weight %, more preferably about 0.01 to about 5.0 weight %, and most preferably about 0.01 to about 1.0 weight %, HALS, based on the total weight of the composition.

Polymeric sheets may be formed by any process known in the art, such as extrusion, calendering, solution casting or injection molding. The parameters for each of these processes can be easily determined by one of ordinary skill in the art depending upon viscosity characteristics of the polymeric material and the desired thickness of the sheet.

The sheet is preferably formed by extrusion. Extrusion is particularly preferred for formation of “endless” products, such as films and sheets, which emerge as a continuous length. In extrusion, the polymeric material, whether provided as a molten polymer or as plastic pellets or granules, is fluidized and homogenized. Preferably, the melt processing temperature of the polymeric compositions is about 50° C. to about 300° C., more preferably about 100° C. to about 250° C. The polymeric compositions have excellent thermal stability, which allows for processing at high enough temperatures to reduce the effective melt viscosity. Recycled polymeric compositions of the present may be used along with the virgin polymeric compositions. This mixture is then forced through a suitably shaped die to produce the desired cross-sectional sheet shape. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders may be used as known in the art. Different kinds of die are used to produce different products, such as sheets and strips (slot dies) and hollow and solid sections (circular dies). In this manner, sheets of different widths and thickness may be produced. After extrusion, the polymeric sheet is taken up on rollers or as flat sheets, cooled and taken off by means of suitable devices which are designed to prevent any subsequent deformation of the sheet.

The polymeric sheet has a thickness of about 20 mils (0.50 mm) or greater, based on enhanced penetration strength of the laminates produced therefrom. Preferably, the polymeric sheet has a thickness of about 30 mils (0.75 mm) or greater, more preferably about 50 mils (1.25 mm) or greater, based on further enhanced penetration strength of the laminates produced therefrom. For many applications, polymer sheets are preferably about 20 to about 300 mils (0.50-7.62 mm), more preferably about 30 to 180 mils (0.75-4.57 mm), and most preferably about 50 to 120 mils (1.25-3.05 mm), and are commonplace. The enhanced penetration strength is necessary to satisfy many of the current mandated requirements for hurricane and threat resistance. Many end uses in the current environment require the ethylene copolymer interlayer to be even thicker. Interlayers of at least about 60 mils (1.50 mm), at least about 90 mils (2.25 mm), and even at least about 120 mils (3.00 mm), are becoming commonplace within the marketplace. For these applications, interlayers of up about 600 mils (15 mm) or more are contemplated.

The polymeric sheet can have a smooth surface. Preferably, the polymeric sheet to be used as an interlayer within laminates has a roughened surface to effectively allow most of the air to be removed from between the surfaces of the laminate during the lamination process. (See, e.g., US 2003-0124296 and US 2006-0141212 A1) This may be accomplished, for example, by mechanically embossing the sheet after extrusion or by melt fracture during extrusion of the sheet and the like. For example, the as extruded sheet may be passed over a specially prepared surface of a die roll positioned in close proximity to the exit of the die which imparts the desired surface characteristics to one side of the molten polymer. Thus, when the surface of such roll has minute peaks and valleys, sheet formed of polymer cast thereon will have a rough surface on the side which contacts the roll which generally conforms respectively to the valleys and peaks of the roll surface. Such die rolls are disclosed in, for example, U.S. Pat. No. 4,035,549. As is known, this rough surface is only temporary and particularly functions to facilitate deairing during laminating after which it is melted smooth from the elevated temperature and pressure associated with autoclaving and other lamination processes.

The polymeric sheet can be combined with other polymeric materials during extrusion and/or finishing to form laminates or multilayer sheets with improved characteristics. A multilayer or laminate sheet may be made by any method known in the art, and may have as many as five or more separate layers joined together by heat, adhesive and/or tie layer, as known in the art. One of ordinary skill in the art will be able to identify appropriate process parameters based on the polymeric composition and process used for sheet formation.

The sheet properties may be further adjusted by adding certain additives and fillers to the polymeric composition, such as colorants, dyes, plasticizers, lubricants antiblock agents, slip agents, and the like, as recited above. For example, a liquid elastomer, such as an isoprene-butadiene-isoprene resin commercially available from the Mobil Chemical Company, (for example, RMR® isoprene-butadiene-isoprene liquid elastomer), may be added to the resins for the purpose of impact modification and as a processing aide, if desired.

The sheets can be further modified to provide valuable attributes to the sheets and to the laminates produced therefrom. For example, the sheets can be treated by radiation, for example E-beam treatment of the sheets. E-beam treatment of the sheets with an intensity in the range of about 2 MRd to about 20 MRd will provide an increase in the softening point of the sheet (Vicat Softening Point) of about 20° C. to about 50° C. Preferably, the radiation intensity is from about 2.5 MRd to about 15 MRd.

The laminates can take many forms. Further embodiments include certain non-autoclave processes to produce certain laminates which comprise at least one rigid sheet and at least one sheet comprised of the certain ethylene acid copolymer ionomers described above; certain laminates which comprise of at least two rigid sheets and at least one sheet comprised of the certain ethylene acid copolymer ionomers described above; certain laminates which comprise of at least one rigid sheet, at least one sheet comprised of the certain ethylene acid copolymer ionomers described above, and at least one polymeric film; and certain laminates which comprise at least two rigid sheets, at least two sheets comprised of the certain ethylene acid copolymer ionomers and at least one polymeric film; laminates produced thereby, and uses thereof.

The polymeric film generally has a thickness of about 1 mil (0.025 millimeters (mm)) to about 10 mils (0.25 mm). The polymeric film may be composed of essentially any material known within the art. Preferably, the polymeric film is transparent. More preferable polymeric film materials include; poly(ethylene terephthalate), polycarbonate, polypropylene, polyethylene, polypropylene, cyclic polyloefins, norbornene polymers, polystyrene, syndiotactic polystyrene, styrene-acrylate copolymers, acrylonitrile-styrene copolymers, poly(ethylene naphthalate), polyethersulfone, polysulfone, nylons, poly(urethanes), acrylics, cellulose acetates, cellulose triacetates, vinyl chloride polymers, polyvinyl fluoride, polyvinylidene fluoride and the like. Most preferably, the polymeric film is biaxially oriented poly(ethylene terephthalate) film.

The polymeric film may include additives and fillers. The additives may include plasticizers, processing aides, flow enhancing additives, lubricants, pigments, dyes, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like, as described above. For example, typical colorants may include a bluing agent to reduce yellowing, a colorant may be added to color the laminate or control solar light.

If higher levels of adhesion are desired within the laminates, silane coupling agents may be incorporated into the films or serve as coatings on the films. Specific examples of the useful silane coupling agents include; gamma-chloropropylmethoxysilane, vinyltrichlorosilane, vinyltriethoxysilane, vinyltris(beta-methoxyethoxy)silane, gamma-methacryloxypropyltrimethoxysilane, beta-(3,4-epoxycyclohexyl)ethyltrimethoxysilane, gammaglycidoxypropyltrimethoxysilane, vinyl-triacetoxysilane, gamma-mercaptopropyltrimethoxysilane, gamma-aminopropyltrietholxysilane, N-beta-(aminoethyl)-gamma-aminopropyl-trimethoxysilane, poly(allyl amine), and the like and combinations thereof. In one preferred embodiment, silane coupling agents aren't used.

Multilayer films may also be used, such as bilayer, trilayer, and multilayer film structures. One advantage to multilayer films is that specific properties can be tailored into the film to solve critical use needs while allowing the more costly ingredients to be relegated to the outer layers where they provide the greater needs.

The polymeric film is preferably heat stabilized to reduce shrinkage through the lamination process. Shrinkage can be controlled by holding the film in a stretched position and heating for a few seconds before quenching. This heat stabilizes the oriented film, which then may be forced to shrink only at temperatures above the heat stabilization temperature. Further, the film may also be subjected to rolling, calendering, coating, embossing, printing, or any other typical finishing operations known within the art.

Preferably, one or both surfaces of the polymeric film can be treated to enhance the adhesion to the polymeric sheet. This treatment can take any form known within the art, including adhesives, primers, such as silanes (which in one preferred embodiment are not used), flame treatments, such as disclosed within U.S. Pat. No. 2,632,921, U.S. Pat. No. 2,648,097, U.S. Pat. No. 2,683,894, and U.S. Pat. No. 2,704,382, plasma treatments, such as disclosed within U.S. Pat. No. 4,732,814, electron beam treatments, oxidation treatments, corona discharge treatments, chemical treatments, chromic acid treatments, hot air treatments, ozone treatments, ultraviolet light treatments, sand blast treatments, solvent treatments, and the like and combinations thereof. For example, a thin layer of carbon may be deposited on one or both surfaces of the polymeric film through vacuum sputtering as disclosed in U.S. Pat. No. 4,865,711. As another example, U.S. Pat. No. 5,415,942 discloses a hydroxy-acrylic hydrosol primer coating that may serve as an adhesion-promoting primer for poly(ethylene terephthalate) films.

Preferably, the polymeric film includes a primer coating on one or both surfaces, more preferably both surfaces, comprising a coating of a polyallylamine-based primer. The polyallylamine-based primer and its application to a polyester film are disclosed within U.S. Pat. No. 5,411,845, U.S. Pat. No. 5,770,312, U.S. Pat. No. 5,690,994, and U.S. Pat. No. 5,698,329. The preferred polyester film is a poly(ethylene terephthalate) film. Generally, the polyester film is extruded and cast as a film by conventional methods and the polyallylamine coating is applied to the poly(ethylene terephthalate) film either before stretching or between the machine direction stretching and transverse direction stretching operations, and/or after the two stretching operations and heat setting in the stenter oven. It is preferable that the coating be applied before the transverse stretching operation so that the coated poly(ethylene terephthalate) web is heated under restraint to a temperature of about 220° C. in the stenter oven in order to cure the polyallylamine to the polyester surface(s). In addition to this cured coating, an additional polyallylamine coating can be applied on it after the stretching and stenter oven heat setting in order to obtain a thicker overall coating

The thickness of the polymeric film is not critical and may be varied depending on the particular application. Generally, the thickness of the polymeric film will preferably range from about 0.1 mils (0.003 mm) to about 15 mils (0.38 mm), more preferably about 0.5 mils, (0.013 mm) to about 8 mils (0.20 mm). For automobile windshields, the polymeric film thickness may preferably be about 1 mil (0.025 mm) to about 4 mils (0.1 mm).

The polymeric film may have a hard coat layer on one or both surfaces. Any hard coat formulation known within the art may be utilized. Generally, the hard coat layers are formed from an ultraviolet (UV) curing resin. Any resin which is UV curable will be usable, for example, the UV curing matrix materials described above. Specific examples of materials for the UV curing resin include, for example, oligomers such as urethane oligomers, polyester oligomers and epoxy oligomers which have two or more ethylenically double bonds and mono- or polyfunctional oligomers such as, for example, pentaerythritol tetraacrylate (PETA), pentaerythritol tetramethacrylate, dipentaerythritol hexaacrylate (DPEHA) and the like and mixtures thereof. The UV curing resin generally consists of an oligomer, a photoinitiator and, if desired, a reactive diluent (monomer). Specific examples of the photoinitiator includes, for example, benzoin, benzophenone, benzoyl methyl ether, benzoin ethyl ether, benzoin isopropyl ether, benzoin isobutyl ether, dibenzyl, 5-nitroacenaphtene, hexachlorocyclopentadiene, p-nitrodiphenyl, p-nitroaniline, 2,4,6-trinitroaniline, 1,2-benzanthraquinone, 3-methyl-1,3-diaza-1,9-benzanthrone, and the like and mixtures thereof. The level of the diluent is preferably within the range of about 0.1 weight % to about 10 weight %, more preferably about 0.5 weight % to about 5 weight %, based on the total weight of the UV curable resin. The level of the photoinitiator is preferably equal to or less than about 5 weight % based on the total weight of the UV curable resin. For example, one preferred minimum is 0.1 weight %.

The hard coat may incorporate further additives or be modified to provide other desirable attributes, such as a high scratch-resistance. Generally, to enhance the scratch resistance of the hard coat layer, the pencil hardness must be increased. Preferably, the scratch-resistant hard coat layer should have a pencil hardness of about 5H or greater, more preferably about 8H or greater, most preferably about 9H or greater. The hard coat may contain fine particles of SiO2, TiO2, ZrO2, Al2O3 or MgO to improve the hardness and wear resistance. These particles are basically transparent and do not lower the transmittance of visible light by a film. An example of a scratch-resistant hard coat layer additive includes UVCH1105® resin commercially available from the Toshiba Silicone Corporation. Abrasion resistant polysiloxane and oligomeric hardcoat materials are disclosed within US 2005-0077002 A1. Further examples of abrasion resistant silica and organic silanol coatings are disclosed within U.S. Pat. No. 4,177,315.

The hard coat layer may further incorporate fog-resistant additives to prevent dew condensation and the loss of film transparency thereby. This is especially important when a surface of the polymeric film forms an outside layer of the laminates. Generally, to provide fog-resistance, hydrophilic oligomers and monomers or surfactants (especially wetting agents) are utilized. The fog-resistant hard coat layer can be formed using, for example, DIABEAM® MH-3263 resin available from the Mitsubishi Rayon Co., Ltd.

The hard coat layer may further incorporate additives which provide high gloss, preferably a glass level of at least 95 (according to JIS K 7105) or greater. An example of the high gloss hard coat layer can be formed using, for example, ADEKA OPTMER® KR-567, available from the ASAHI DENKA KOGYO K.K. Company.

The hard coat layer may further incorporate additives which provide high solvent resistance, especially excellent solvent resistance to highly polar solvents, such as N,N′-dimethylformamide. Generally, such solvent resistant hard coat compositions will include a hydrophobic additive, such as, for example, a silicon- or fluorine-modified oligomers, monomers or resin. An example of a solvent resistant hard coat composition is, for example, Silicone Hard Coat Agent® KP851 resin available from the Shin-Etsu Chemical Co., Ltd.

The hard coat layer may further incorporate additives which increase the moisture barrier properties of the film. Generally, such moisture barrier hard coat compositions will include a hydrophobic additive, such as, for example, a silicon- or fluorine-modified oligomers, monomers or resin. An example of a moisture barrier hard coat composition is, for example, Ultraviolet Curing Resin having Low Permeability available from NIPPON KASEI Co., Ltd.

The polymeric film may incorporate functional coatings. One example of the polymeric film coated with a solar control layer includes metallized substrate films, such as polyester films, which have electrically conductive metal layers, such as aluminum or silver metal, typically applied through a vacuum deposition or a sputtering process. These supported metal stacks are disclosed within glass laminates in, for example, U.S. Pat. No. 3,718,535, U.S. Pat. No. 3,816,201, U.S. Pat. No. 3,962,488, U.S. Pat. No. 4,017,661, U.S. Pat. No. 4,166,876, U.S. Pat. No. 4,226,910, U.S. Pat. No. 4,234,654, U.S. Pat. No. 4,368,945, U.S. Pat. No. 4,386,130, U.S. Pat. No. 4,450,201, U.S. Pat. No. 4,465,736, U.S. Pat. No. 4,782,216, U.S. Pat. No. 4,786,783, U.S. Pat. No. 4,799,745, U.S. Pat. No. 4,973,511, U.S. Pat. No. 4,976,503, U.S. Pat. No. 5,024,895, U.S. Pat. No. 5,069,734, U.S. Pat. No. 5,071,206, U.S. Pat. No. 5,073,450, U.S. Pat. No. 5,091,258, U.S. Pat. No. 5,189,551, U.S. Pat. No. 5,264,286, U.S. Pat. No. 5,306,547, U.S. Pat. No. 5,932,329, U.S. Pat. No. 6,391,400, U.S. Pat. No. 6,455,141, and EP 160 510. The metallized films are generally disclosed to reflect the appropriate light wavelengths to provide the solar control properties desired. Other solar control films may incorporate functional nanoparticles, such as antimony tin oxide and indium tin oxide nanoparticles, either as coatings or as fillers within the resin matrix of the film. Further examples include polymeric films coated with antimony tin oxide, (ATO), nanoparticles incorporated within a matrix material which are commercially available. For example, the Sumitomo Osaka Cement Company offers a line of solar control films within their RAYBARRIER® film product offering. The RAYBARRIER® solar control films are described as antimony tin oxide nanoparticles with a nominal particle size of about 10 nm dispersed within a matrix material and coated on biaxially stretched poly(ethylene terephthalate) film. The RAYBARRIER® solar control films are also typically hardcoated to improve the abrasion resistance. Specific grades of RAYBARRIER® solar control films include; RAYBARRIER® TFK-2583 solar control film, RAYBARRIER® TFM-5065 solar control film, RAYBARRIER® SFJ-5030 solar control film, RAYBARRIER® SFI-5010 solar control film, RAYBARRIER® SFH-5040 solar control film and RAYBARRIER® SFG-5015 solar control film. Further examples include polymeric films coated with indium tin oxide, (ITO), nanoparticles incorporated within a matrix material, which are also commercially available. For example, the Tomoegawa Paper Company, Ltd., of Tokyo, Japan, offers a line of solar control films within their Soft Look® film product offering. The Soft Look® solar control films are described as indium tin oxide nanoparticles dispersed within a matrix material and solution coated on biaxially stretched poly(ethylene terephthalate) film. The Soft Look® solar control films also incorporate a UV shielding hard coat layer ontop of the indium tin oxide infrared shielding layer and may further incorporate adhesive layers as the outer layers of the films. Specific grades of Soft Look® solar control films include; Soft Look® UV/IR 25 solar control film and Soft Look® UV/IR 50 solar control film.

The laminates can optionally include additional layers, such as other polymeric sheets and films. The “additional layer” polymeric film and sheets may provide additional attributes, such as acoustical barriers. Polymeric films and sheets which provide acoustical dampening include, for example, ethylene vinyl acetate copolymers, ethylene methyl acrylate copolymers, ethylene butyl acrylate copolymers, ethylene acid copolymers and ionomers derived therefrom, plasticized polyvinyl chloride resins, metallocene-catalyzed polyethylene compositions, polyurethanes, highly plasticized polyvinyl butyral compositions, silicone/acrylate (“ISD”) resins, and the like. Such “acoustic barrier” resins are disclosed within, for example, U.S. Pat. No. 5,368,917, U.S. Pat. No. 5,624,763, U.S. Pat. No. 5,773,102, and U.S. Pat. No. 6,432,522. Preferably, the “additional layers” polymeric film or sheet is selected from the group consisting of polycarbonate, polyurethane, acrylic sheets, polymethylmethacrylate, polyvinyl chloride, polyester, poly(vinyl butyral), acoustic poly(vinyl acetal), acoustic poly(vinyl butyral), and poly(ethylene-co-vinyl acetate). As noted above, adhesives or primers may be included, especially to provide adequate adhesion between the other polymeric layer and the interlayer.

The rigid sheet may be glass or rigid transparent plastic sheets, such as, for example, polycarbonate, acrylics, polyacrylate, cyclic polyolefins, such as ethylene norbornene polymers, metallocene-catalyzed polystyrene and the like and combinations thereof. Metal or ceramic plates may be substituted for the rigid polymeric sheet or glass if clarity is not required for the laminate.

The term “glass” is meant to include not only window glass, plate glass, silicate glass, sheet glass, and float glass, but also includes colored glass, specialty glass which includes ingredients to control, for example, solar heating, coated glass with, for example, sputtered metals, such as silver or indium tin oxide, for solar control purposes, E-glass, Toroglass, and the like. Such specialty glasses are disclosed in, for example, U.S. Pat. No. 4,615,989, U.S. Pat. No. 5,173,212, U.S. Pat. No. 5,264,286, U.S. Pat. No. 6,150,028, U.S. Pat. No. 6,340,646, U.S. Pat. No. 6,461,736, and U.S. Pat. No. 6,468,934. The type of glass to be selected for a particular laminate depends on the intended use.

Adhesives and primers may be used to enhance the bond strength between the laminate layers, if desired. Any adhesive or primer known within the art may be utilized. Preferably, the adhesives and primers are as described above. This should not be taken as limiting. The adhesives may be applied through melt processes or through solution, emulsion, dispersion, and the like, coating processes. One of ordinary skill in the art will be able to identify appropriate process parameters based on the polymeric composition and process used for the coating formation. The above process conditions and parameters for making coatings by any method in the art are easily determined by a skilled artisan for any given polymeric composition and desired application.

The non-autoclave lamination processes comprise at least one vacuum step. The use of a vacuum step within the lamination process provides high quality laminates in high yield and shortens the lamination process. The non-autoclave lamination process may take many forms.

The applying vacuum is preferably conducted by applying a vacuum of about 20 mm Hg to 400 mm mercury (Hg), preferably 20 to 100 Hg, more preferably 25-50 mm Hg (absolute pressure).

The non-autoclave lamination process can comprise placing the prelaminate assembly under vacuum and heating to form the final laminate. In a typical process, a glass sheet, an ionomer interlayer and a second glass sheet are laminated together under heat and pressure and a vacuum (for example, in the range of about 27-28 inches (689-711 mm) Hg, (about 0-100 mm Hg absolute pressure)), to remove air. Preferably, the glass sheets have been washed and dried. A typical glass type is about 2 to about 6 mm (preferably about 2.5 to about 3.5 mm)thick annealed flat glass and it is preferred to orient the tin side of the glass to the interlayer to achieve the ultimate adhesion. In a typical procedure, the interlayer is positioned between two glass plates to form a glass/interlayer/glass assembly, placing the assembly into a bag capable of sustaining a vacuum (“a vacuum bag”), drawing the air out of the bag using a vacuum line or other means of pulling a vacuum on the bag (the laminate may be subjected to the vacuum at essentially room temperature for a period of about 1 minute to about 1 hour to facilitate the removal of any volatiles), sealing the bag while maintaining the vacuum, placing the sealed bag in an oven at a temperature of about 100° C. to about 200° C. for from about 10 to about 50 minutes. Preferably the bag is heated at a temperature of from about 120° C. to about 160° C. for 20 minutes to about 45 minutes. A vacuum ring may be substituted for the vacuum bag. One type of vacuum bag is disclosed within U.S. Pat. No. 3,311,517. The temperature may be staged or ramped, if desired.

In another embodiment, the above process may be modified by adding a heat soak step after releasing the vacuum. For example, after the laminate goes through the heat cycle under a vacuum, as described above, the vacuum may be released and the laminate may further be heated at a temperature of about 100° C. to about 180° C. for a further about 1 minute to about 1 hour. Preferably, the laminate is further heated at a temperature of about 100° C. to about 160° C. for about 5 minutes to about 30 minutes.

In a further embodiment, the laminate assembly is placed in a vacuum and heated sufficiently to form an edge-sealed “pre-press”, the vacuum is released and the edge-sealed pre-press further heated to form the final laminate. For example, the interlayer is positioned between two glass plates to form a glass/interlayer/glass assembly, placing the assembly into a vacuum bag, drawing the air out of the bag using a vacuum line or other means of pulling a vacuum on the bag, sealing the bag while maintaining the vacuum, placing the sealed bag in an oven at a temperature of about 50° C. to about 100° C. for from about 1 minute to about 1 hour. Preferably the vacuum bag is heated to a temperature of about 70° C. to about 90° C. for a time of about 5 minutes to about 30 minutes. This allows for out-gassing of the interlayer and preliminary bonding of the glass to the interlayer to form what is generally referred to within the art as an “edge-sealed pre-press”. The vacuum may then optionally be released and the laminate heated from about 100° C. to about 180° C., for from about 10 to about 50 minutes. Preferably the laminate is heated at a temperature of from about 120° C. to about 160° C. for 20 minutes to about 45 minutes. The heating may be performed within ovens, radiant heating, microwave heating, or hot air.

As a preferable embodiment of the present invention, the above described edge-sealed pre-press assembly produced through a vacuum process can be heated followed by passing it through nip rolls which compress the assembly to form the laminate. (The nip rolls can be heated nip rolls of the type generally known within the art.) This type of process would be more robust and provide the potential for a continuous process. For example, the above described edge-sealed pre-press assembly may be subjected to heating by passing through a heating zone, such as an oven. Heating should be to a temperature sufficient to promote fusion bonding. Suitable temperatures for the preferred polymeric sheets of the present invention is within the range of about 100° C. to about 200° C., with the preferred surface temperatures reaching about 120° C. to about 160° C. The heated glass/interlayer/glass assembly is then fed along through nip rolls where the layers are merged together under pressure to form a laminate. If desired, the nip rolls may be heated to promote the bonding process. The bonding pressure exerted by the nip rolls may vary with the polymeric sheet materials and the temperatures employed. Generally the bonding pressure will be within the range of about 10 psi (0.7 kg/sq cm) to about 120 psi (8.4 kg/sq cm), or greater. The heat zone/nip roll process may be repeated until the desired laminate is produced. Alternatively, a continuous operation may be employed whereby the laminate assembly is passed through a vacuum chamber with heating to form the edge sealed pre-press assembly which then successively passes through many oven-nip roll combinations. (US 2004/0182493 discloses the alternating heat/nip roll processes, which can be practices after forming the edge-sealed pre-press through a vacuum process.) The number of ovens and nip rolls may be 3, or 6, or 9 or even more, depending on the desired operation. The nip rolls may have a graduated smaller gap as one travels down the process to apply greater pressure to the assembly, or they may have the same gap. For example, the non-autoclave process may include laying up a glass/interlayer of the present invention/glass assembly, optionally preheating the assembly to a temperature of from about 30° C. to about 50° C., either through oven heating, radiant heating, microwave heating or through the use of hot air blowing on the assembly. The heated assembly may then be passed through a vacuum step, such as a vacuum chamber, as described above. Next the assembly pre-press is heated to a temperature of from about 60° C. to about 180° C. through oven heating, radiant heating, microwave heating or through the use of hot air blowing on the pre-press assembly. Preferably, the assembly pre-press is heated to a temperature of from about 60° C. to about 130° C. The heated pre-press assembly is then passed through a second set of nip rolls to form the laminate. As one skilled within the art would appreciate, such a process may be modified by, for example, the staging or ramping of the heat through multiple heat zones and by the use of more sets of nip rolls, such as a total of 3, 4, 5, or more sets of nip rolls. As described above, the nip rolls may have a graduated smaller gap as one travels down the process to apply greater pressure to the assembly, or they may have the same gap.

More complex non-autoclave processes which include sequential or simultaneous uses of heat, vacuum and pressure may be utilized within the present invention. For example, a process which includes sequentially subjecting the laminate assembly to vacuum, a heat zone, while still under vacuum or not, a pressing zone, while still under vacuum or not, and a venting zone which returns to laminate to atmospheric pressure, and all of the variations and modification thereof, may be utilized. Such a process is disclosed within, for example, U.S. Pat. No. 6,342,116.

The above reference to specific examples should not be considered limiting, as variations are readily apparent.

The process may be easily modified to make a wide variety of laminates. For example, the process can produce laminates with the following structures:

| | | | | |
|---|---|---|---|---|
| Glass or rigid sheet | Ionomer | | | |
| | sheet | | | |
| Ionomer sheet | Film | | | |
| Glass or rigid sheet | Ionomer | Film | | |
| | sheet | | | |
| Glass or rigid sheet | Ionomer | Glass or rigid | | |
| | sheet | sheet | | |
| Glass or rigid sheet | Ionomer | Acoustic | Glass or | |
| | sheet | polymeric | rigid sheet | |
| | | sheet (not | | |
| | | ionomer) | | |
| Glass or rigid sheet | Ionomer | Film | Ionomer | Glass or |
| | sheet | | sheet | rigid |
| | | | | sheet |
| Glass or rigid sheet | Ionomer | Film | Interlayer | Glass or |
| | sheet | | sheet (non- | rigid |
| | | | ionomer) | sheet |
| Glass or rigid sheet | Ionomer | Polymeric film | Acoustic | Glass or |
| | sheet | | polymeric | rigid |
| | | | sheet (non- | sheet |
| | | | ionomer) | |
| Glass or rigid sheet | Ionomer | Glass or rigid | Ionomer | Glass or |
| | sheet | sheet | sheet | rigid |
| | | | | sheet |

In the above table, the term “glass or rigid sheet” is used to refer to rigid layers of glass and plastic materials that are used in place of glass to form windows and similar objects. They are generally transparent, but that can be semi-transparent or opaque if desired. Examples of rigid sheet that can be used as an alternative to glass are polycarbonate sheets and acrylic sheets described above. These layers can be colored. The layers might be all glass, all plastic transparent material, or mixtures thereof such as glass/ionomer sheet/rigid layer/ionomer/glass sheet. Other examples include: solar glass sheet/ionomer sheet/colored glass sheet and green glass sheet/ionomer sheet/solar control polymeric film/ionomer sheet/glass sheet (preferably clear). (Examples of solar glass sheets are glass that include an IR absorber/reflector or that is coated with a IR absorber/reflector.)

By “film” is meant the types of polymer films described above, for example: biaxially-oriented poly(ethylene terephthalate) film, solar control polymeric film, polymeric film with a sputtered metal solar control layer. The polymeric film may optionally incorporate functional additives or coatings, as described above.

Examples of polymeric sheet interlayers that can be used along with the ionomer sheet in forming multiple layer laminates include, for example, polyvinyl butyral, poly(ethylene-co-vinyl acetate), polyurethanes and the like, or may be a functional sheet serving as an acoustic barrier, as described above, or for solar control purposes.

As a further example, a glass/ionomer sheet/Teflon® film or other strippable film/cover plate (such as, for example, another glass sheet) assembly may can produce a glass/ionomer sheet laminate once the cover plate and the Teflon® film are removed. Similarly, a glass/ionomer sheet /polymeric film (as described above)/cover plate (such as, for example another glass plate) assembly can produce a glass/ionomer sheet/polymeric film laminate once the cover plate is removed. The polymeric film may optionally incorporate functional additives or coatings, as described above.

Variations on these embodiments are readily apparent. For instance, six layer, seven layer (e.g., glass/interlayer/glass/interlayer/glass/interlayer/glass), or laminates with even greater numbers of layers can be produced.

As described above, adhesives, primers, and “additional layers” of polymeric sheets and films may be incorporated into the laminates.

Abrasion resistant, hard coats, as described above, may be applied to the laminate, especially to outer interlayers or outer polymeric films and sheets. The hard coats help to protect the outer polymeric layers from scratching, abrasion, and the like. Hard coat compositions are common within the art, but may take the form as disclosed, for example, above or in U.S. Pat. No. 4,027,073.

Preferably, the laminate has the structure of glass/ionomer interlayer sheet/glass. For architectural uses and for uses in transportation such as automobiles, trucks, and trains, a typical laminate has two layers of glass and directly self-adhered to the glass is an interlayer. The laminate has an overall thickness of about 3 mm to about 30 mm. The interlayer typically has a thickness of about 0.38 mm to about 4.6 mm and each glass layer usually is at least 1 mm thick or thicker (typically in the range of 2 mm to 6 mm). The interlayer is preferably adhered directly to the glass and an intermediate adhesive layer or coating between the glass and the interlayer is not required.

### EXAMPLES

### Analytical Methods

Compressive Shear Strength

Compressive Shear Strength was determined through the method disclosed in U.S. Pat. No. 6,599,630. Essentially, the compressive shear strength of the laminate was determined using the method detailed here. Six 1″ by 1″ (25 mm by 25 mm) chips were sawed from the laminate. The chips were conditioned in a room controlled at 23 C +/−2° C. and 50% +/−1% relative humidity for one hour prior to testing. The compre shear strength of the chip was determined using jig shown in FIG. 1 of U.S. Pat. No. 6,599,630. The chip was placed on the cut-out on the lower half of the jig, and the upper half was then placed on top of the chip. A cross-head was lowered at the rate of 0.1 inch per minute (2.5 mm per minute) until it contacts the upper piece of the device. As the cross-head continues to travel downward, one piece of glass of the chip begins to slides relative to the other. The compressive shear strength of the chip was the shear stress required to cause adhesive failure. The precision of this test is such that one standard deviation is typically 6% of the average result of six chips.

Pummel Adhesion

The pummel adhesion of the samples was measured by the following procedure. For each test, a portion of the laminate, typically having dimensions of 15 by 30 cm, was subjected to the pummel test. The pummel testing was performed at room temperature (about 20° C. to about 25° C.). It was then held in a pummel testing machine at a 5 angle to a supporting table. A force was evenly applied over a 10 by 15 cm area of the sample with a 450 g flathead hammer at a predetermined rate until the glass became pulverized. Once the glass pulverized, the glass remaining glued to the polymeric interlayer was compared with a list of formal standards. These standards comprise a scale ranging from 0 to 10 and are given as:

Percent Of The Surface Of The Polymeric Interlayer
Pummel That Came Unglued During Breaking Values

| | |
|---|---|
| 100 | 0 |
| 95 | 1 |
| 90 | 2 |
| 85 | 3 |
| 60 | 4 |
| 40 | 5 |
| 20 | 6 |
| 10 | 7 |
| 5 | 8 |
| 2 | 9 |
| 0 | 10 |

The pummel test was performed on both surfaces of the laminated glass and a pummel value recorded for each surface tested. In general, good glass retention performance is maintained after glass fracture due to impact when laminates exhibit a pummel adhesion of greater than 5.

The pummel data reported herein is based upon an average of more than one sample.

Peel Adhesion

Glass laminate peel adhesion was measured by subjecting the laminates to 90 degree peel strength adhesion testing. The laminates were peeled at a 90-degree angle using an INSTRUMENTORS, Inc., Model SP-102B-3M90 SLIP/PEEL Tester. The laminates were peeled at a rate of 1 inch per minute.

### Examples 1-9

6 inch by 7 inch (152 mm×178 mm) by 40 mil thick plaques were produced through compression molding on a Carver Melt Press (Carver, Inc., Wabash, Ind.) from the copoly(ethylene-co-methacrylic acid)s described in Table 1 (incorporating the weight percentage of methacrylic acid and neutralized as described in Table 1). The compression molding was conducted at a temperature of 190° C. and a pressure of 20,000 psi. The plaques were cooled to room temperature over approximately 30 minutes. The plaques were then packaged in moisture barrier packaging.

Glass laminates composed of a glass layer, the plaque produced above, and a second glass layer were produced in the following manner. The samples were laid up with a clear annealed float glass plate layer (6 inches by 7 inches by 2.5 mm thick, tin side of glass layer in contact with the plaque interlayer in Examples 1-3 and 7-9 and air side of glass layer in contact with the plaque interlayer in Examples 4-6), the plaque produced above, and a second clear annealed float glass plate layer (6 inches by 7 inches by 2.5 mm thick, tin side of glass in contact with the plaque interlayer in Examples 1-3 and 7-9 and air side of glass layer in contact with the plaque interlayer in Examples 4-6). The glass/interlayer/glass assembly was then placed into a vacuum bag and evacuated to a vacuum of 29 inches Hg (about 25 mm Hg absolute pressure) for 10 minutes to remove any air contained between the glass/interlayer/glass assembly. The glass/interlayer/glass pre-press assembly contained within the evacuated vacuum bag was then placed into a preheated oven at a temperature of 120° C. for 30 minutes (45 minutes in examples 7, 8 and 9). The vacuum bag-glass laminate was then removed from the oven, the glass/interlayer/glass laminate removed from the vacuum bag and the as produced glass/interlayer/glass laminate was allowed to air cool to room temperature.

Results are described below.

TABLE 1
Examples 1-9

| | | | | Glass | Heat | | Pummel |
|---|---|---|---|---|---|---|---|
| | Methacrylic | Neutralization | Neutralization | Surface | Soak | Compressive | Adhesion |
| Ex. | Acid (wt %) | Ion | (%) | Laminated | (min) | Shear Strength | (Average) |
| 1 | 19 | Sodium | 37 | Tin | 30 | 2,755 | 1 |
| 2 | 21.4 | Sodium | 31 | Tin | 30 | 4,395 | 5 |
| 3 | 21.4 | Zinc | 32 | Tin | 30 | 3,744 | 4 |
| 4 | 19 | Sodium | 37 | Air | 30 | 3,150 | 2 |
| 5 | 21.4 | Sodium | 31 | Air | 30 | 2,884 | 2 |
| 6 | 21.4 | Zinc | 32 | Air | 30 | 4,279 | 3.5 |
| 7 | 19 | Sodium | 37 | Tin | 45 | 1,989 | 1.5 |
| 8 | 21.4 | Sodium | 31 | Tin | 45 | 3,627 | 5 |
| 9 | 21.4 | Zinc | 32 | Tin | 45 | 3,635 | 5.5 |

These results demonstrate that non-autoclave processes can be successfully practiced with the copolymers of the invention. In addition, they show that higher acid level resins provide significantly higher glass adhesion, which is desirable for threat resistant safety glass laminates. They further show that zinc-neutralized resins provide significantly higher glass adhesion, which is desirable for threat resistant safety glass laminates.

### Comparative Example 1

Plaques were produced as described in Example 1 from a terpoly(ethylene-co-isobutylacrylate-co-methacrylic acid) incorporating 10 weight % isobutyl acrylate and 10 weight % methacrylic acid which was neutralized to a level of 73% with zinc. Glass laminates were produced as described with respect to Examples 7, 8 and 9. The laminates had a Compressive Shear Strength (average of three laminates) of 2,595 psi, and a Pummel Adhesion of 6. These low modulus materials do not perform as threat resistant glass. In addition, these laminates do not have the adhesion properties of the laminates prepared with zinc-neutralized copolymers. Further, they do not have the optical clarity of the laminates prepared with copolymers of the invention.

### Example 10

A copoly(ethylene-co-methacrylic acid) incorporating 19 weight % methacrylic acid which was neutralized to a level of 37% with sodium was extrusion cast into sheets in the following manner. The copolymer was fed into a 1.5-inch diameter Killion extruder with a temperature profile:

| Extruder | Temperature |
|---|---|
| Zone | (C.) |
| Feed | Ambient |
| Zone 1 | 160 |
| Zone 2 | 200 |
| Zone 3 | 200 |
| Block | 210 |
| Die | 210 |

Polymer throughput was controlled by adjusting the screw speed to 70 rpm. The extruder fed a 14-inch “coathanger” die with a nominal gap of 0.038-inch. The as cast sheet was fed into a three roll stack consisting of a 6-inch diameter rubber nip roll covered with a Teflon® release film and two 12-inch diameter polished chrome chill rolls held at a temperature of about 10° C. to about 15° C. This provided nominally 0.030-inch thick sheet.

### Example 11

A copoly(ethylene-co-methacrylic acid) incorporating 19 weight % methacrylic acid which was neutralized to a level of 37% with zinc was extrusion cast into sheets with a nominal thickness of 0.030-inch as described in Example 10.

### Example 12

A copoly(ethylene-co-methacrylic acid) incorporating 19 weight % methacrylic acid which was neutralized to a level of 36% with zinc was extrusion cast into sheets with a nominal thickness of 0.030-inch as described in Example 10.

### Example 13

A copoly(ethylene-co-methacrylic acid) incorporating 19 weight % methacrylic acid which was neutralized to a level of 32% with zinc was extrusion cast into sheets with a nominal thickness of 0.030-inch as described in Example 10.

### Example 14

Laminates composed of a glass layer and the ethylene copolymer sheet produced in Example 10 were produced in the following manner. The ethylene copolymer sheets produced in Example 10 (6 inches by 12 inches by 30 mils thick, (0.030 inch)) were conditioned at less than 8% relative humidity (RH) at a temperature of 72° F. overnight. The laminates were laid up to provide an annealed float glass sheet layer (6 inches by 12 inches by 2.5 mm thick, tin side in contact with the interlayer) the Example 10 sheet layer, a thin Teflon® film layer, and a polycarbonate sheet (6 inches by 12 inches by ⅛ inch thick). The glass sheet/Example 10 interlayer/Teflon® film/polycarbonate sheet assembly was then placed into a vacuum bag and evacuated to a vacuum of 29 inches Hg (about 25 mm Hg absolute pressure) for 10 minutes to remove any air contained between the glass/interlayer/Teflon® film/polycarbonate sheet assembly. The glass/interlayer/Teflon® film/polycarbonate assembly contained within the evacuated vacuum bag was then placed into a preheated oven at a temperature of 110° C. for 45 minutes. The vacuum bag-glass laminate was then removed from the oven, the glass/interlayer/Teflon® film/polycarbonate laminate removed from the vacuum bag and allowed to cool to room temperature. The polycarbonate sheet and the Teflon® film removed to provide the as produced glass/interlayer laminate.

They were found to have a peel adhesion of 0.9 lbs-in.

### Example 15

Glass/interlayer laminates were produced with the sheet produced in Example 11 as described in Example 14. They were found to have a peel adhesion of 6.1 lbs-in.

### Example 16

Glass/interlayer laminates were produced with the sheet produced according to Example 12 as described in Example 14. They were found to have a peel adhesion of 1.7 lbs-in.

### Example 17

Glass/interlayer laminates were produced with the sheet produced in Example 13 as described in Example 14. They were found to have a peel adhesion of 10.2 lbs-in.

### Example 18

Laminates composed of a glass layer and the ethylene copolymer sheet produced in Example 10 were produced as described in Example 14, except when the laminates were laid up to provide an annealed float glass sheet layer the air side was in contact with the interlayer. They were found to have a peel adhesion of 1.0 lbs-in.

### Example 19

Glass/interlayer laminates were produced with the sheet produced in Example 11 as described in Example 18. They were found to have a peel adhesion of 1.2 lbs.

### Example 20

Glass/interlayer laminates were produced with the sheet produced in Example 12 as described in Example 18. They were found to have a peel adhesion of 1.6 lbs-in.

### Example 21

Glass/interlayer laminates were produced with the sheet produced in Example 13 as described in Example 18. They were found to have a peel adhesion of 1.4 lbs-in.

### Example 22

Laminates composed of a glass layer and the ethylene copolymer sheet produced in Example 10 were produced as described in Example 14, except the glass/interlayer/Teflon® film/polycarbonate assembly contained within the evacuated vacuum bag was placed into a preheated oven at a temperature of 120° C. for 45 minutes. The laminates were found to have a peel adhesion of 1.3 lbs-in.

### Example 23

Glass/interlayer laminates were produced with the sheet produced in Example 11 as described in Example 22. They were found to have a peel adhesion of 6.3 lbs-in.

### Example 24

Glass/interlayer laminates were produced with the sheet produced in Example 12 as described in Example 22. They were found to have a peel adhesion of 3.0 lbs-in.

### Example 25

Glass/interlayer laminates were produced with the sheet produced in Example 13 as described in Example 22. They were found to have a peel adhesion of 13.0 lbs-in.

### Example 26

Laminates were prepared as described in Example 18, except the glass/interlayer/Teflon® film/polycarbonate assembly contained within the evacuated vacuum bag was placed into a preheated oven at a temperature of 120° C. for 45 minutes. The laminates were found to have a peel adhesion of 1.0 lbs-in.

### Example 27

Glass/interlayer laminates were produced with the sheet produced in Example 11 as described in Example 26. They were found to have a peel adhesion of 2.1 lbs-in.

### Example 28

Glass/interlayer laminates were produced with the sheet produced in Example 12 as described in Example 26. They were found to have a peel adhesion of 1.8 lbs-in.

### Example 29

Glass/interlayer laminates were produced with the sheet produced in Example 13 as described in Example 26. They were found to have a peel adhesion of 3.7 lbs-in.

TABLE 2
Examples 14-29

| | | | | | Glass | Heat Soak | Peel |
|---|---|---|---|---|---|---|---|
| | | Methacrylic | Neutralization | Neutralization | Surface | (temp | Adhesion |
| Ex. | Sheet | Acid (wt %) | Ion | (%) | Laminated | ° C./time, min) | (lbs-in) |
| 14 | Ex. 10 | 19 | Sodium | 37 | Tin | 110/45 | 0.9 |
| 15 | Ex. 11 | 19 | Zinc | 37 | Tin | 110/45 | 6.1 |
| 16 | Ex. 12 | 19 | Zinc | 36 | Tin | 110/45 | 1.7 |
| 17 | Ex. 13 | 19 | Zinc | 32 | Tin | 110/45 | 10.2 |
| 18 | Ex. 10 | 19 | Sodium | 37 | Air | 110/45 | 1.0 |
| 19 | Ex. 11 | 19 | Zinc | 37 | Air | 110/45 | 1.2 |
| 20 | Ex. 12 | 19 | Zinc | 36 | Air | 110/45 | 1.6 |
| 21 | Ex. 13 | 19 | Zinc | 32 | Air | 110/45 | 1.4 |
| 22 | Ex. 10 | 19 | Sodium | 37 | Tin | 120/45 | 1.3 |
| 23 | Ex. 11 | 19 | Zinc | 37 | Tin | 120/45 | 6.3 |
| 24 | Ex. 12 | 19 | Zinc | 36 | Tin | 120/45 | 3.0 |
| 25 | Ex. 13 | 19 | Zinc | 32 | Tin | 120/45 | 13.0 |
| 26 | Ex. 10 | 19 | Sodium | 37 | Air | 120/45 | 1.0 |
| 27 | Ex. 11 | 19 | Zinc | 37 | Air | 120/45 | 2.1 |
| 28 | Ex. 12 | 19 | Zinc | 36 | Air | 120/45 | 1.8 |
| 29 | Ex. 13 | 19 | Zinc | 32 | Air | 120/45 | 3.7 |

These results demonstrate that non-autoclave processes can be successfully practiced with the copolymers of the invention. In addition, they show laminates made with zinc-neutralized resins provide significantly higher glass adhesion, which is desirable for threat resistant safety glass laminates.

### Examples 30-43 & C2-C5

Glass laminates were prepared from 300-mm square lites of glass which had been washed thoroughly with trisodium phosphate followed by a thorough rinsing with deionized water and dried. The laminate assembly was formed by placing one lite of glass into a vacuum chamber, then the polymer interlayer and finally a second piece of glass on top to form a laminate assembly. The chamber was closed and the air rapidly removed (about 30 seconds) to an absolute pressure of 50 mm Hg absolute pressure. Heat was supplied to the laminate assembly primarily from the bottom and the sample was allowed to heat up to various temperatures (as described in Table 3) for various time periods. Pressure was then applied to the laminate assembly by inflating a bladder within the chamber providing essentially uniform pressure over the surface area of the sample. The applied pressure was either about 1 pounds/sq. in. or about 13 pounds/sq. in. Pressure was applied to in an attempt to insure contact of the glass and plastic layers. It was found that samples of this size prepared with flat annealed glass and polymer interlayer sheeting with good flatness could be prepared using relatively low bladder pressure (˜1 pound/sq.in). In some cases, samples were prepared by deliberately placing a shim of polymer interlayer (0.5-cm×10-cm by 0.38 mm thickness) in the center of the laminate assemble on top of the flat interlayer sheet (either to mimic a non-flat interlayer sheet or non-flat glass) thus creating a gap in the laminate assembly prior to processing. Samples produced in this manner required higher applied bladder pressure (13 pounds/sq. in.) to flatten and to bring the glass layers and polymer interlayer into complete contact as necessary for a laminate fully bonded over the entire surface area and to be free of bubbles and other defects. Dwell time and temperature along with the rheological properties of the interlayer determined in these cases whether optical distortion is present in the resulting laminate due to the laminate not being ‘optically’ flat. Air was then reintroduced back into the chamber generally while maintaining the application of the ‘bladder’ pressure (the chamber returning back to atmospheric pressure) and the laminate was allowed to cool completely. The continued application of bladder pressure was found to not be necessary for samples that had developed an adequate and complete bond between the glass and polymer interlayer prior to reintroducing air back into the chamber.

To allow for measurement of peel adhesion, some samples were prepared as above with the exception of the second piece of glass was not placed on top but a thin 1/16″ sheet of silicone (50 durometer) over the plastic sheeting to provide a relatively flat surface for the lamination step. All steps were then carried out as stated above. Afterwards, 90 degree angle peel adhesion measurements were made on a variety of samples produced by the process above.

The samples were then inspected for visual clarity, defects, bubbles, etc. and notations were made.

TABLE 3
Examples C2-C5 & 30-43

| | | Metha- | | Neutrali- | Glass | Heat Soak | | Peel | |
|---|---|---|---|---|---|---|---|---|---|
| | | crylic Acid | Neutrali- | zation | Surface | (temp | Percent | Adhesion | Bake Test |
| Ex. | Sheet | (wt %) | zation Ion | (%) | Laminated | ° C./time, | Haze | (lbs-in) | @ 150 C. |
| C2 | PVB | N/a | N/a | N/a | Tin | 120/45 | 8.1 | 20.8 | ~80% |
| | | | | | | | | | Bubbles |
| 30 | Ex. 10 | 19 | Sodium | 37 | Tin | 120/45 | 0.9 | 1.3 | Clear |
| 31 | Ex. 11 | 19 | Zinc | 37 | Tin | 120/45 | 1.1 | 5.7 | Clear |
| | | | | | | | | | ~50% |
| C3 | PVB | N/a | N/a | 37 | Air | 120/45 | 6.5 | 22.0 | Bubbles |
| 32 | Ex. 10 | 19 | Sodium | 32 | Air | 120/45 | 0.8 | 0.8 | Clear |
| 33 | Ex. 11 | 19 | Zinc | 37 | Air | 120/45 | 1.0 | 5.2 | Clear |
| | | | | | | | | | Massive |
| 34 | Ex. 10 | 19 | Sodium | 32 | Tin | 90/45 | 41.5 | 0.3 | bubbles |
| | | | | | | | | | Massive |
| 35 | Ex. 11 | 19 | Zinc | 37 | Tin | 90/45 | 39.9 | 0.7 | bubbles |
| 36 | Ex. 10 | 19 | Sodium | 32 | Tin | 150/8 | 1.0 | 2.0 | Clear |
| 37 | Ex. 11 | 19 | Zinc | 37 | Tin | 150/8 | 1.0 | 7.9 | Clear |
| 38 | Ex. 5* | 21.4 | Sodium | 31 | Tin | 120/45 | 0.6 | 4.8 | Clear |
| 39 | Ex. 6* | 21.4 | Zinc | 32 | Tin | 120/45 | 0.8 | 19.6 | Clear |
| 40 | Ex. 5* | 21.4 | Sodium | 31 | Tin | 150/8 | 0.7 | 6.8 | Clear |
| 41 | Ex. 6* | 21.4 | Zinc | 32 | Tin | 150/8 | 0.9 | 29.9 | Clear |
| 42 | Ex. 5* | 21.4 | Sodium | 31 | Air | 150/8 | 0.5 | 4.2 | Clear |
| 43 | Ex. 6* | 21.4 | Zinc | 32 | Air | 150/8 | 0.6 | 19.9 | Clear |
| C4 | Ex. 5* | 21.4 | Sodium | 31 | Air | A/C | 0.9 | 5.1 | Clear |
| | | | | | | 150/30 | | | |
| C5 | Ex. 6* | 21.4 | Zinc | 32 | Air | A/C 150/30 | 1.0 | 24.1 | Clear |

*Note:
All samples in Table 3 above were in the form of 30-mil sheet thickness

Comparison of Example C2 with Examples 30 and 31 and Example C3 with Examples 32 and 33 demonstrate that the lamination process of the invention is optimized for the interlayers of the invention to provide safety glass laminates. Common poly(vinyl butyral) (PVB) interlayers do not provide adequate safety laminates based on a high number of bubbles.

The results summarized within Table 3 further demonstrate that the preferable zinc-neutralized ionomers consistently provide superior safety glass laminates than comparable sodium-neutralized ionomers under comparable lamination conditions. The Table 3 results further demonstrate that the preferable high acid ionomers with 21.4 wt % MAA (Example 38-43) consistently provide superior safety glass laminates than lower acid ionomers with 19 wt % MAA (Examples 30-37).

Comparison of Examples C4 and C5 produced through a common art autoclave process with Examples 42 and 43 produced through the non-autoclave lamination process of the invention demonstrates the production of comparable safety glass laminates with a surprisingly more time efficient process of the invention.

The lamination process of the invention coupled with the ionomer interlayers of the invention have been found to provide a surprisingly simplified lamination process. It has been generally been found within the art that greater adhesion is obtained through adhering the interlayer with the tin side of the glass. This forces the glass laminator to identify the tin side of the glass and to turn the large glass sheets. As demonstrated in Examples within Table 3, adequate safety glass laminates are provided with the interlayers and lamination process of the invention with significantly less differentiation between the air side and the tin side of the glass providing a simplified lamination process.

We claim:

1. A non-autoclave process of manufacturing a glass laminate comprising:
(a) providing an assembly comprising (i) a first rigid sheet layer, and (ii) an interlayer sheet comprising a copolymer comprising units from an alpha olefin and about 17 weight % to about 25 weight % of units from an alpha, beta-ethylenically unsaturated carboxylic acid, groups wherein about 1 to about 100 mole % of the carboxylic acid groups are neutralized with metal ions selected from the group consisting of sodium, zinc, and mixtures thereof; and
(b) forming the glass laminate from the assembly without use of an autoclave comprising in sequence (i) removing air to an absolute pressure of 20 mm to 100 mm Hg in a vacuum chamber containing the assembly; (ii) heating the assembly while still under vacuum; (iii) applying pressure to the assembly by inflating a bladder within the chamber; (iv) reintroducing air to the chamber.

2. The process of claim 1 wherein step (iii) comprises bringing the chamber to atmospheric pressure.

3. The process of claim 1 wherein step (iii) is conducted while still maintaining bladder pressure.

4. The process of claim 1 wherein step (iii) is conducted without maintaining bladder pressure.

5. The process of claim 1 further comprising step (v) of cooling.

6. The process of claim 1 wherein the carboxylic is neutralized to about 20 to about 40% with zinc ions.

7. The process of claim 1 wherein the alpha,beta-ethylenically unsaturated carboxylic acid comonomers are selected from the group consisting of acrylic acid, methacrylic acid, and mixtures thereof.

8. The process of claim 6 wherein the copolymer is copoly(ethylene-co-methacrylic acid).

9. The process of claim 7 wherein the process is carried out without use of organic peroxides in the interlayer.

10. The process of claim 7 wherein the process is carried out without use of adhesion primers.

11. The process of claim 1 wherein the interlayer sheet has a thickness of about 20 to about 300 mils.

12. The process of claim 9 wherein the interlayer sheet has a thickness of about 30 to 180 mils.

13. The process of claim 1 wherein the copolymers incorporate about 17 weight % to about 23 weight % of the alpha,beta-ethylenically unsaturated carboxylic acid comonomers, based on the total weight of the polymer.

14. The process of claim 1 wherein the copolymers incorporate about 20 weight % to about 23 weight % of the alpha,beta-ethylenically unsaturated carboxylic acid comonomers, based on the total weight of the polymer.

15. The process of claim 1 wherein the assembly comprises from top to bottom (i) the first rigid sheet layer, (ii) the interlayer sheet, and (iii) a second rigid sheet layer.

16. The process of claim 1 wherein the assembly comprises from top to bottom (i) the first rigid sheet layer, (ii) the interlayer sheet, and (iii) a film.

17. The process of claim 15 wherein the first rigid sheet layer is a glass sheet and the second rigid sheet layer is a glass sheet.

18. The non-autoclave process of claim 1 wherein the heating is carried out at about 80 to about 160° C.

19. The non-autoclave process of claim 1 wherein the heating is carried out at about 50 to about 130° C.
